(19) United States
(12) Patent Application Publication
(10) Pub. No.: US 2026/0030558 A1
(43) Pub. Date: Jan. 29, 2026

(54) Incremental learning of a gradient boosted decision tree model for malicious file detection

(71) Applicant: Palo Alto Networks (Israel Analytics) Ltd., Tel Aviv (IL)

(72) Inventors: Yinnon Meshi, Kibbutz Revivim (IL); Gal Itzhak, Holon (IL); Eran Tamari, Kfar Saba (IL); Niv Sela, Tel Aviv-Yafo (IL)

(21) Appl. No.: 18/782,039

(22) Filed: Jul. 24, 2024

(51) Int. Cl. G06N 20/20; G06F 21/55

(52) U.S. Cl. CPC G06N 20/20; G06F 21/552; G06F 2221/033

(57) ABSTRACT

A method, including receiving first files, having respective first labels, and extracting respective first features from the files. A model including a set of decision trees is trained based on the respective features and labels of the files. Some but not all of the trees in the set are removed from the model so as to define an abridged model including an abridged set of the trees. Upon receiving second files, which are different from the first files and have respective second labels, respective second features are extracted from the second files, and respective classification scores are computed for the first and the second files by applying the abridged model. An augmented model is trained by adding further trees to the abridged set based on the respective scores and respective labels and features of the first and the second files, and the augmented model is applied to classify further files.

### FIELD OF THE INVENTION

The present invention relates generally to computer security, and particularly to a rapid retraining of a malicious file detection model based on gradient boosting decision trees.

### BACKGROUND OF THE INVENTION

Gradient boosting trees is a type of machine learning technique that combines multiple weak models, usually simple decision trees, to create a stronger model. The idea is to iteratively train new weak models that can predict the errors of the previous strong model, and then add them to the strong model with a negative sign to reduce the error. This process continues until a certain stopping criterion is met, such as a maximum number of iterations or a validation error threshold.

Some of the benefits of gradient boosting trees are that they can handle different types of features, such as numerical, categorical, or ordinal, and that they can capture complex nonlinear relationships and interactions among the features. Some of the challenges of gradient boosting trees are that they can be prone to overfitting, especially if the weak models are too complex or the learning rate is too high, and that they can be computationally expensive and hard to parallelize, compared to other ensemble methods like random forests.

The description above is presented as a general overview of related art in this field and should not be construed as an admission that any of the information it contains constitutes prior art against the present patent application.

### SUMMARY OF THE INVENTION

A method for protecting a computer system, including receiving first files, having respective first labels indicating whether the first files are harmful to operation of the computer system, extracting respective first features from the first files, training, by a processor, an initial gradient-boosted decision model including an initial set of decision trees based on the respective features and labels of the first files, after training the initial gradient-boosted decision model, removing from the trained model some but not all of the decision trees in the initial set so as to define an abridged gradient-boosted decision model including an abridged set of the decision trees, receiving second files, which are different from the first files and have respective second labels indicating whether the second files are harmful to operation of the computer system, extracting respective second features from the second files, computing respective initial classification scores for the first and the second files by applying the abridged gradient-boosted decision model to their respective features, training, by the processor, an augmented gradient-boosted decision model by adding further decision trees to the abridged set based on the respective initial classification scores and respective labels and features of the first and the second files, and applying the augmented gradient-boosted decision model to classify further files as either harmful or unharmful to the operation of the computer system.

In one embodiment, the labels and the classification scores include verdicts indicating whether their respective files are harmful to operation of the computer system.

In a first verdict embodiment, the second label for a given second file indicates a first verdict, and the initial classification score for the given second file indicates a second verdict different from the first verdict.

In a second verdict embodiment, a subset of the second files have specified respective similarities to the given second file, and one or more of the second files in the subset have respective second labels different from the first verdict.

In a third verdict embodiment, one or more of the second files in the in the subset have respective second labels matching the first verdict.

In a fourth verdict embodiment, the specified similarity includes a distance score between the one or more additional second files and the given second file.

In a fifth verdict embodiment, the distance score includes trend locality sensitive hash (TLSH) distance scores, wherein the specified similarity includes detecting that the TLSH distance scores are within a specified threshold of each other.

In another embodiment, removing some but not all of the decision trees in the initial set includes removing a specified number of the decision trees from the initial set.

In an additional embodiment, the initial gradient-boosted decision model includes a ordered sequence of the decision trees in the initial set from a front end of the initial gradient-boosted decision model to a back end of the initial gradient-boosted decision model, wherein removing the specified number of the decision trees from the initial set includes removing the specified number of the decision trees from the back end of the initial gradient-boosted decision model.

In a further embodiment, the method further includes computing, for each given decision tree in the initial set, a tree significance measure indicating its respective impact on the initial gradient-boosted decision model, wherein removing the specified number of the decision trees from the initial set includes removing the specified number of the decision trees whose respective tree significance measure least impacts the initial gradient-boosted decision model.

In a first tree removal embodiment, computing the tree significance measure for a given decision tree in the initial set includes computing respective test classifications for the first and the second files by applying the given decision tree to their respective features, and comparing the test classifications to the respective labels of the first and the second files, wherein the tree significance measure for the given decision tree indicates an accuracy of the given decision tree.

In a second tree removal embodiment, the decision trees in the initial set include respective sets of leaf nodes, and the method further includes computing respective leaf values for the leaf nodes, and computing the tree significance measure for a given leaf node by identifying one or more of the first files that fall into the given leaf node, and performing a computation on the identified one or more files.

In a supplemental embodiment, the computation is selected from a list consisting of a sum, a maximum, an average and a value.

In one embodiment, the further set of the decision trees includes a specified number of further decision trees.

In another embodiment, training the initial gradient-boosted decision model includes generating the initial set of decision trees with a first value for a parameter, wherein adding a further set of the decision trees includes generating a further set of the decision trees with a second value for the parameter that is different than the first value for the parameter.

In a first training embodiment, the parameter includes a maximum tree depth.

In a second training embodiment, the parameter includes a learning rate.

In a third training embodiment, the second incremental learning rate parameter is less than the first incremental learning rate parameter.

In an additional embodiment training the augmented gradient-boosted decision model includes applying different respective weights to the first and the second files.

In a first weighting embodiment, the weight for the first files is greater than the weight for the second files.

In a second weighting embodiment, the weight for the first files includes a first weight for the first files labeled as harmful to operation of the computer system, and a second weight for the first files labeled as not harmful to operation of the computer system, wherein the first weight is different than the second weight.

In a third weighting embodiment, the weight for the second files includes a first weight for the second files labeled as harmful to operation of the computer system, and a second weight for the second files labeled as not harmful to operation of the computer system, wherein the first weight is different than the second weight.

There is also provided, in accordance with an embodiment of the present invention, an apparatus for protecting a computer system, including a memory, and a processor configured to receive first files, having respective first labels indicating whether the first files are harmful to operation of the computer system, to extract and store to the memory respective first features from the first files, to train an initial gradient-boosted decision model including an initial set of decision trees based on the respective features and labels of the first files, after training the initial gradient-boosted decision model, to remove from the trained model some by not all of the decision trees in the initial set so as to define an abridged gradient-boosted decision model including an abridged set of the decision trees, to receive second files, which are different from the first files and have respective second labels indicating whether the second files are harmful to operation of the computer system, to extract and store to the memory respective second features from the second files, to compute respective initial classification scores for the first and the second files by applying the abridged gradient-boosted decision model to their respective features, to train an augmented gradient-boosted decision model by adding further decision trees to the abridged set based on the respective initial classification scores and respective labels and features of the first and the second files, and to deploy the augmented gradient-boosted decision model so as to apply the augmented gradient-boosted decision model to classify further files as either harmful or unharmful to the operation of the computer system.

There is additionally provided, in accordance with an embodiment of the present invention, a computer software product for protecting a computing system, the computer software product including a non-transitory computer-readable medium, in which program instructions are stored, which instructions, when read by a computer, cause the computer to receive first files, having respective first labels indicating whether the first files are harmful to operation of the computer system, to extract respective first features from the first files, to train an initial gradient-boosted decision model including an initial set of decision trees based on the respective features and labels of the first files, after training the initial gradient-boosted decision model, to remove from the trained model some by not all of the decision trees in the initial set so as to define an abridged gradient-boosted decision model including an abridged set of the decision trees, to receive second files, which are different from the first files and have respective second labels indicating whether the second files are harmful to operation of the computer system, to extract respective second features from the second files, to compute respective initial classification scores for the first and the second files by applying the abridged gradient-boosted decision model to their respective features, to train an augmented gradient-boosted decision model by adding further decision trees to the abridged set based on the respective initial classification scores and respective labels and features of the first and the second files, and to apply the augmented gradient-boosted decision model to classify further files as either harmful or unharmful to the operation of the computer system.

### BRIEF DESCRIPTION OF THE DRAWINGS

The disclosure is herein described, by way of example only, with reference to the accompanying drawings, wherein:

FIG. 1 is a block diagram showing an example of a model training server that is configured to train and deploy, to a host computer, gradient-boosting decision models that are configured to detect malicious files, in accordance with an embodiment of the present invention;

FIG. 2 is a block diagram showing hardware, software and data components of the model training server, in accordance with an embodiment of the present invention;

FIG. 3 is a block diagram showing data components of a model information record used by the model training server, in accordance with an embodiment of the present invention;

FIG. 4 is a block diagram showing data components of a training classification summary generated by the model training server, in accordance with an embodiment of the present invention; and

FIG. 5 is a flow diagram that schematically illustrates a method for rapid retraining of a gradient-boosting decision tree model configured to detect malicious files, in accordance with an embodiment of the present invention.

### DETAILED DESCRIPTION OF EMBODIMENTS

Gradient-boosting decision trees is an effective technique for creating classification models configured to detect malicious files. Once deployed, performance of these models can be monitored, e.g., by tracking both false positives and any malwares that were undetected (i.e., false negatives).

Performance (i.e., accuracy of classifications) of these classification models typically degrades over time. In particular, new malware families are continually being created and discovered, so the ability to update the model is of great importance. One way of updating a classification model is to retrain the classification model using a new training sample dataset. However, this approach has some disadvantages, such as:
A full retrain of the model may yield an entirely different model, which highly differs from the existing one that currently executes in production. Therefore, a fully retrained model may cause errors in certain areas that may be difficult to detect. For example, files correctly classified by an original classification model my not be correctly classified by a fully retrained classification model.
Retraining the model can be time-consuming and computationally expensive.

Embodiments of the present invention provide methods and systems for rapidly retraining a file classification model based on gradient boosting decision trees. As described hereinbelow, a set of first files are received that have respective first labels indicating whether the first files are harmful to operation of a computer system. respective first features are extracted from the first files, and an initial gradient-boosted decision model comprising an initial set of decision trees is trained based on the respective features and labels of the first files.

After training the initial gradient-boosted decision model, some but not all of the decision trees in the initial set are removed from the trained model so as to define an abridged (i.e., a partial) gradient-boosted decision model comprising an abridged set of the decision trees. Upon receiving second files, which are different from the first files and have respective second labels indicating whether the second files are harmful to operation of the computer system, respective second features are extracted from the second files, and respective initial classification scores for the first and the second files are computed by applying the abridged gradient-boosted decision model to their respective features (i.e., the respective first features for the first files and the respective second features for the second files).

An augmented gradient-boosted decision model can then be trained by adding further decision trees to the abridged set based on the respective initial classification scores and respective labels and features of the first and the second files (i.e., the respective first labels and first features for the first files and the respective second labels and second features for the second files). Finally, the augmented gradient-boosted decision model can be deployed and applied to further files so as to classify the further files as either harmful or unharmful to the operation of the computer system.

In some embodiments, the second files comprise additional files (e.g., files storing data ready for use in operational processes or distribution) that were not correctly classified by the initial gradient-boosted decision model. In these embodiments, distance scores can be used to select further files that are similar to the additional files and have different labels. Therefore, upon detecting a given additional file that was misclassified by the initial gradient-boosted decision model, a first group of further files can be identified that are similar to the given additional file and are labeled as benign, a second group of further files can be identified that are similar to the given additional file and are labeled as malicious, and the given additional file and the identified further files can be added to the second files. Benign and malicious labels and classifications are described hereinbelow.

Systems implementing embodiments of the present invention have an ability to fix local problems in the initial gradient-boosted decision model (e.g. a new malware family that was missed) while also preserving the model's knowledge in the areas it performs well. Since the augmented gradient-boosted decision model is highly similar to the initial gradient-boosted decision model (i.e., that already runs in production), embodiments described herein provide a smooth path for upgrading the initial gradient-boosted decision model, as both models should behave similarly in most cases.

While embodiments described herein can be used to rapidly retrain a gradient-boosted decision model for detecting files that can be harmful to operation of computer systems, using these embodiments to detect other types of types of cybersecurity attacks is considered to be within the spirit and scope of the present invention. For example, embodiments of the present invention can be used to retrain gradient-boosted decision models that detect executing processes (i.e., in memory of a given computer system), or transmissions (to/from a given computer system) that can be harmful to operation of a given computer system.

### System Description

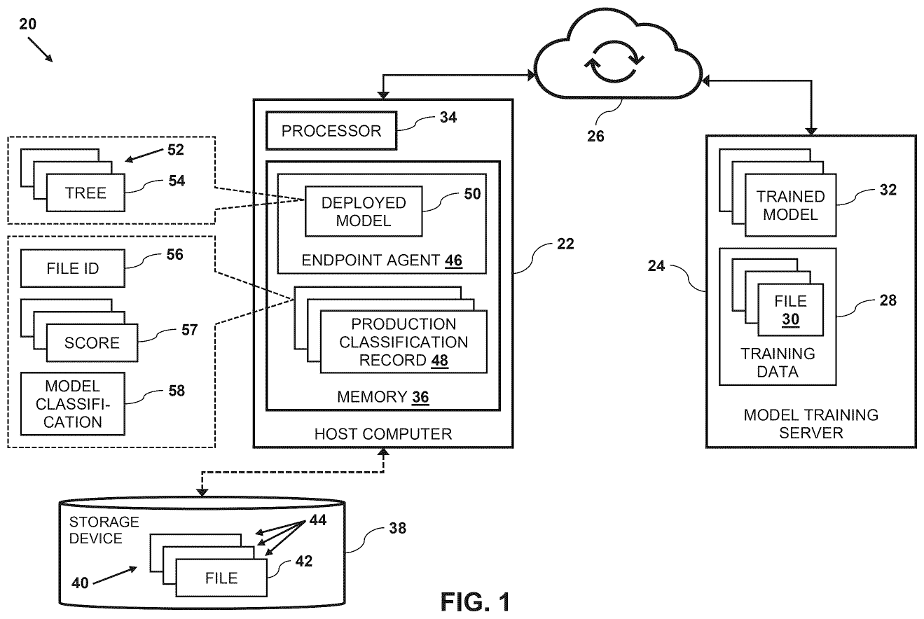

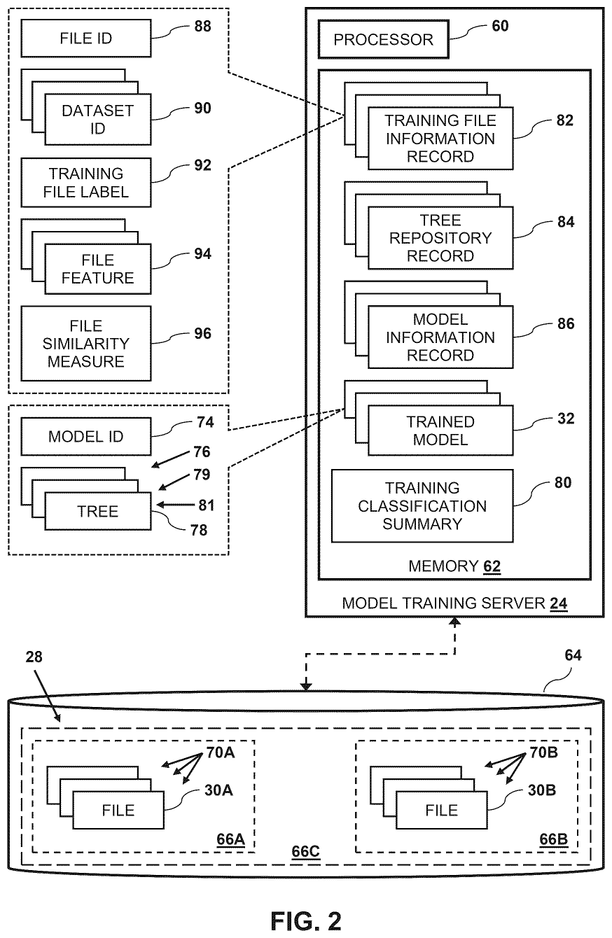

FIG. 1 is a block diagram that shows a computing facility 20 comprising a host computer system 22 and a model training server 24 that can communicate over a data network such as Internet 26. As described hereinbelow, model training server 24 is configured to use training data 28 comprising a set of training files 30 to train a set of trained gradient-boosted decision models 32 (also referred to herein simply as trained models 32). Hardware components and data structures used by model training server 24 are described in the description referencing FIGS. 2-5 hereinbelow.

In the configuration shown in FIG. 1, host computer 22 comprises a host processor 34 and a host memory 36. Host computer 22 is coupled to a host storage device 38. In some embodiments, storage device 38 may comprise a hardware component of host computer 22. In other embodiments, storage device 38 is coupled to Internet 26, and host computer 22 can communicate with the host storage device via the Internet.

Storage device 38 comprises a production set 40 of production files 42 having respective production file identifiers (IDs) 44. In some embodiments, a given file ID 44 may comprise a hash value computed (e.g., SHA256) for its respective file 42.

Memory 36 may comprise an endpoint agent 46 and multiple production classification records 48 that have a one-to-one correspondence with production files 42. In some embodiments, endpoint agent 46 comprises a deployed gradient-boosted decision model 50 (also referred to herein as deployed model 50) that comprises a given trained model 32 comprising a production set 52 of production decision trees 54. In embodiments described herein, deployed model 50 comprises a given trained model 32.

Each given production classification record 48 may comprise a production file ID 56 indicating a corresponding file 42, production tree scores 57 that are generated by corresponding decision trees 54, and a model classification 58 for the corresponding file 42. In embodiments herein, processor 34 can generate each given model classification 58 (typically a verdict as to whether the corresponding file 42 is malicious) by comparing (one or more) scores 57 to (one or more) respective specified thresholds so as to indicate whether the corresponding production file can be harmful to the operation of host computer 22. In these embodiments, processor 34 can apply decision trees 54 to files 30 so as to compute scores 57, and generate model classification 58 based on one or more of the production tree scores.

In embodiments of the present invention, if a specific file (e.g., a given production file 42) is classified or labeled as benign, then the specific file is not suspected to be harmful to the operation of host computer 22. However, if the specific file is classified or labeled as malicious, then the specific file is suspected to be harmful to the operation of host computer 22.

In embodiments described herein, a label for a given file (e.g., a given production file 42) is a “ground truth” indicating whether the given file is either harmful or unharmful to the operation of a computer system. Likewise, a classification for a given file comprises a (computed) prediction as to whether the given file is harmful (or unharmful) to the operation of a computer system. In these embodiments, if the label for a given file is malicious then the given file can harm a computer system, and the label for a given file is benign, then the given file is not harmful to the operation of a computer system. Additionally, classifying a given file as harmful to the operation of the computer system may also be referred to as classifying the given file as malicious, and classifying a given file as unharmful to the operation of the computer system may also be referred to as classifying the given file as benign.

Examples of harmful actions that can be caused by production files 42 (or training files described hereinbelow) labeled or classified as malicious include, but are not limited to, exfiltrating (i.e., stealing) or damaging data, removing or stealing privileges, launching a ransomware attack that prevents access to files, and phishing attacks.

Endpoint agent 46 (also known as an endpoint security agent or a security agent) comprises a software application that processor 34 can execute (typically in the background) so as to generate (i.e., by applying deployed model 50 to files 42) production classifications 48. One example of endpoint security agent 46 is CORTEX XDR™ produced by PALO ALTO NETWORKS INC., 3000 Tannery Way, Santa Clara, CA 95054 USA).

FIG. 2 is a block diagram showing an example configuration of model training server 24, in accordance with an embodiment of the present invention. Model training server 24 may comprise a server processor 60 and a server memory 62. Model training server 24 is coupled to a server storage device 64 that stores training data 28. In some embodiments, storage device 38 may comprise a hardware component of model training server 24. In other embodiments, storage device 64 is coupled to Internet 26, and model training server 24 can communicate with the server storage device via the Internet.

Training data 28 comprises a plurality of training datasets 66 (also referred to herein simply as sets 66) of training files 30 having respective training file IDs 70. In some embodiments, a given file ID 70 may comprise a hash value computed (e.g., SHA256) for its respective file 30.

In the example shown in FIG. 2, training datasets 66, training files 30 and training file IDs 70 can be differentiated by appending a letter to the identifying numeral, so that the training datasets comprise training datasets 66A-66C, the training files comprise training files 30A and 30B, and the training file IDs comprise training file IDs 70A and 70C. In embodiments herein, training dataset 66A comprises training files 30A having respective training file IDs 70A, training dataset 66B comprises training files 30B having respective training file IDs 70B, and training dataset 66C comprises a union of training datasets 66A and 66B.

In the configuration shown in FIG. 2, memory 62 comprises a set of trained models (also referred to herein as gradient-boosted decision models) 32 having respective model IDs 74 and comprising respective sets 76 of decision trees 78 having respective sets of leaf nodes 79 and respective root nodes 81. Memory 62 also comprises training classification summary 80 and respective sets of training file information records 82 that have a one-to-one correspondence with training files 30, decision tree repository records 84 that have a one-to-one correspondence with decision trees 78, and trained model information records 86 that have a one-to-one correspondence with trained models 32.

In embodiments described herein, each given training file information record 82 comprises information that processor 60 can use so as to generate trained models 32 by generating their respective decision trees 78. In these embodiments, each given training file information record 82 may comprise information for its corresponding training file 30 such as:
A file ID 88 comprising training file ID 70 for the corresponding training file.
One or more dataset IDs 90 referencing one or more respective training datasets 66 to which the corresponding training file belongs. Note that a given training file 30 can belong to one or more training datasets 66. For example, in the configuration shown in FIG. 2, training files in training datasets 66A and 66B also belong to training dataset 66C.
A training file label 92 (i.e., a ground truth) indicating whether the corresponding training file the corresponding file can be harmful to the operation of host computer 22. As described supra, the corresponding file can be labeled as (a) benign if the corresponding training file is not deemed to be harmful to the operation of host computer 22, or (b) malicious if the corresponding training file is deemed to be harmful to the operation of the host computer.
A set of file features 94 that processor 60 can extract from the corresponding training file so as to train model(s) 32. Examples of file features 94 are described hereinbelow.
A file similarity measure 96 that processor 60 can compute so as to detect an additional training file 30 that is “similar” to the corresponding training file. In one embodiment similarity measure 96 can be based on a distance score such as a locality-sensitive hashing algorithm such as trend locality sensitive hash (TLSH) values that provides, with high probability, identical hashes to files that are very similar, and also defines a distance measure between the hashes that enable grouping files that are “less similar”. In some embodiments, processor 60 can classify two training files as being “similar” if their respective TLSH distance scores are within a specified threshold of each other (e.g., at least 90%, 95%, or 98%). Information on TLSH can be found at the TLSH.ORG website.

In a first feature embodiment, features 94 may comprise information such as a file creation date, a file size, a file type, a hash value computed for the file, and a number of zeros in the file. In a second feature embodiment, if a given file 30 is an executable file, processor 60 can generate file features 94 based on sophisticated strings aggregations, which can provide information about the potential behavior of the given file entity during its execution. In a third feature embodiment processor 60 can generate features 94 based on statistics of code disassembly and code flows.

In a fourth feature embodiment, features 94 may be operating system dependent. For example, if a given file 30 is an executable file for the WINDOWS™, operating system (produced by MICROSOFT CORPORATION, One Microsoft Way, Redmond, WA, USA), processor 60 can extract, from the disk operation system (DOS) and portable executable (PE) header fields that provide metadata about the executable, features 94 such as a compilation timestamp, a checksum and instructions for the WINDOWS™ loader, such as section information and sections page protection.

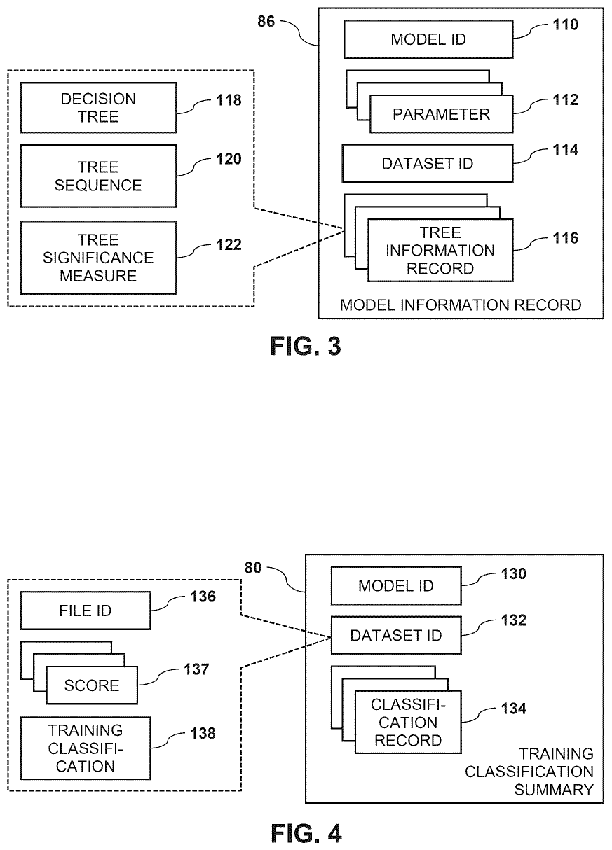

Model information records 86 are described in the description referencing FIG. 3 hereinbelow, and training classification summary 80 are described in the description referencing FIG. 4 hereinbelow.

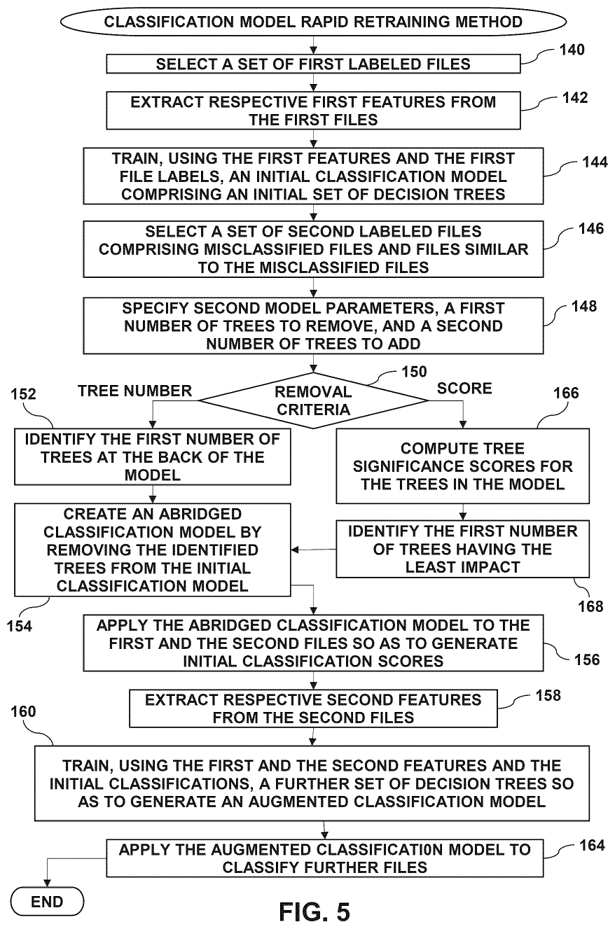

FIG. 3 is a block diagram that shows an example of a given model information record 86, in accordance with an embodiment of the present invention. Each model information record 86 has a corresponding trained model 32, and can store information such as:
A model ID 110 comprising model ID 74 for the corresponding trained model.
One or more parameters 112 that processor 60 can use to generate the corresponding trained model. In embodiments described herein, processor 60 can train a first given model 32 using a first value for a given parameter 112, and retrain the first given model using a second value (different from the first value) for the given parameter so as to generate a second given model 32.
A first example of a given parameter 112 is maximum tree depth. In this example, the second given trained model may allow a first maximum tree depth that is greater than a second maximum tree depth for the first given trained model. For example, the maximum tree depth may be 6 for the first given trained model and 10 for the second given trained model.
A second example of a given parameter 112 is a learning rate (also referred to as an incremental learning rate in the scope of embodiments described herein). As described hereinbelow, processor 60 generates the second given trained model by combining a subset of decision trees 78 in the first given trained model with a further set of decision trees 78. In this example the learning rate for the further set of decision trees can be different (usually less than) than the learning rate for the decision trees in the first given trained model. For example, the learning rate for the first given model (i.e., the model to be retrained) may be 0.1, and the learning rate for the second given model (i.e., the retrained model) may be 0.05.
A third example of a given parameter 112 is weights for training files 30 when generating trained models 78. Examples of the weights processor 60 can use to generate trained models 32 are described in the description referencing FIG. 5 hereinbelow.
A dataset ID 114 referencing a given training dataset 66.
A set of tree information records 116 that have a one-to-one correspondence with decision trees 78 in the corresponding trained model. Each tree information record 116 can store information such as:
   A decision tree 118.
   A tree sequence number 120. As described supra, each given trained model 32 comprises a given set 76 of decision trees 30. In embodiments described herein, processor 60 can use a given trained model 32 to classify a given training file 30 by applying, to the given training file, the decision trees in the given model in a specific sequence. In these embodiments the tree sequence number for the first decision tree applied to the given training file is 1, the tree sequence number for the second decision tree applied to the given training file is 2, and so on.
   A tree significance measure 122 that is described in the description referencing FIG. 5 hereinbelow.

FIG. 4 is a block diagram showing an example of training classification summary 80, in accordance with an embodiment of the present invention. Processor 60 can generate training classification summary 80 in response to applying a given trained model 32 to a given training dataset 66. Training classification summary 80 can store information such as:
A model ID 130 comprising model ID 74 for the given trained model.
A dataset ID 132 indicating a given training dataset 66 storing training files classified by the given trained model.
A set of classification records 134 that have a one-to-one correspondence with training files 30 in the indicated training set. Each given classification record 134 corresponding to a given training file 30 can store information such as:
   A training file ID 136 comprising training file ID 70 for the corresponding training file.
   A set of training classification scores 137 (also referred to herein as classification scores) that correspond to decision trees 118 in the model information record whose model ID 110 matches model ID 130. In these embodiments, processor 60 can apply, to file 30 referenced by file ID 136, decision trees 118 in the model information record whose model ID 110 matches model ID 130 so as to compute scores 137.
   A training classification 138 (i.e., a benign or malicious verdict, as described supra) indicating whether the corresponding training file can be harmful to the operation of host computer 22. In some embodiments, processor 60 can generate classification 138 based on one or more scores 137.

Processors 34 and 60 comprise one or more general-purpose central processing units (CPU) or special-purpose embedded processors, which are programmed in software or firmware to carry out the functions described herein. This software may be downloaded to host computer 22 and/or model training server 24 in electronic form, over a network, for example. Additionally or alternatively, the software may be stored on tangible, non-transitory computer-readable media, such as optical, magnetic, or electronic memory media. Further additionally or alternatively, at least some of the functions of processors 34 and 60 may be carried out by hard-wired or programmable digital logic circuits.

Examples of memories 36 and 62 include dynamic random-access memories and non-volatile random-access memories. Examples of storage devices 38 and 64 include dynamic random-access memories and non-volatile random-access memories, hard disk drives and solid-state disk drives.

In some embodiments, tasks described herein performed by processors 34 and 60 may be split among multiple physical and/or virtual computing devices. In other embodiments, these tasks may be performed in a managed cloud service.

### Rapid Retraining of a File Classification Model

FIG. 5 is a flow diagram that schematically illustrates a method of retraining a first given trained model 32 so as to generate a second trained model 32, in accordance with an embodiment of the present invention.

In step 140, processor 60 selects and receives a first dataset 66 comprising respective first labels 92 for training files 30 in the first dataset. In the description hereinbelow, the first dataset comprises dataset 66A comprising training files 30A.

In one embodiment, processor 60 can use a third-party service to receive labels 92. For example, to receive a given label 92 for a given training file 30, processor 60 can compute a hash value for the given training file, convey the computed hash value to WILDFIRE™ (a service provided by PALO ALTO NETWORKS INC.), and receive, from WILDFIRE™ in response to the conveyed hash value, a given label 92 indicating whether the given training file can be harmful to the operation of host computer 22.

In step 142, processor 60 extracts respective sets of first file features 94 from training files 30A.

In step 144, processor 60 trains, using the first labels and the extracted file features for the first training files, initial trained model 32 comprising an initial set 76 of decision trees 78. In some embodiments, processor 60 can train initial trained 32 model based on parameters 112. To train initial trained model 32, processor 60 can use a software library such as LIGHTGBM™, produced by MICROSOFT CORPORATION, One Microsoft Way, Redmond, WA, USA.

In step 146, processor 60 selects training dataset 66B comprising training files 30B having respective file IDs 70 and respective training file labels 92. In some embodiments, training dataset 66B comprises at least one given training file 30B that was misclassified by initial trained model 32 (i.e., when processor 34 applies a given gradient-boosted decision model 32, to a given training file 30B, the model classification computed by the given gradient-boosted decision model differs from the training file label for the given training file).

In other words, upon processor 60 applying initial trained model 32 to the given training file so as to generate training classification 138, the server processor detects that the generated training classification for the given training file does not match the corresponding training file label 92 (i.e., for the given training file). In these embodiments, either the training classification for the given training file indicates that the given training file is malicious and the training file label for the given training file indicates that the given training file is benign, or the training classification for the given training file indicates that the given training file is benign and the training file label for the given training file indicates that the given training file is malicious.

For each given misclassified training file 30B, processor 60 can collect and add the following subset of training files 30B to training dataset 66B:
One or more training files 30B (i.e., in the subset) that are similar (as described hereinbelow) to the given misclassified training file, and whose respective training file label(s) 92 is/are identical to the training file label for the given misclassified training file.
One or more training files 30B (i.e., in the subset) that are similar (as described hereinbelow) to the given misclassified training file, and whose respective training file label(s) 92 is/are different than the training file label for the given misclassified training file.

In some embodiments, the specified similarity for the misclassified production files and their corresponding “similar” training files 30 can be based on hash computations that processor 60 can compute and store to respective file similarity measures 96. In these embodiments, the hash computation may comprise a TLSH distance score, and the specified similarity comprises identifying files that either have the same TLSH hash or have a low TLSH distance. For example, processor 60 can classify two training files as being “similar” if the TLSH distance measure is within a specified threshold of each other (e.g., at least a 90%, 95%, or 98% similarity score).

As described supra, new malware families are continually being created and discovered. In these cases, initial trained model 32 may (i.e., when deployed) correctly classify a first production file 42, but incorrectly classify a second production file 42. Using embodiments of the present invention, processor 60 can use dataset 30C (i.e., the union of datasets 30A and 30B) to train an augmented trained model 70 that can correctly classify training files 30A and 30B, thereby increasing the accuracy of classifying production files 32.

In step 148, processor 60 specifies parameters 112 for augmented trained model 32. In embodiments of the present invention, the initial trained model comprises initial decision trees 78. Processor 60 generates augmented trained model 32 by first removing a first number of initial decision trees 78 to remove from the initial trained model so as to define an abridged trained model 32. Processor 60 then can generate augmented trained model 32 by training (and thereby adding) a second number of further decision trees 78 for the abridged trained model. In step 148, processor 60 also specifies the first number of initial decision trees 78 to remove and the second number of further decision trees to add.

In one embodiment, the initial trained model comprises a third number of decision trees, and the first number can be a value between greater than or equal to one and less than the third number. In an alternative embodiment, the first number can be zero. In this embodiment, processor 60 generates the augmented trained model by training the second number of further trees for the initial trained model.

Returning to the flow diagram, in step 148, processor 60 can additionally specify the first number (i.e., the number of initial decision trees 78 to remove) and the second number (i.e., the number of further decision trees 78) to add. In some embodiments, parameters 112 may comprise the first and the second numbers.

As described supra, examples of parameters 112 include maximum tree depths, incremental learning rates, and file weights. In a first example, a given parameter 112 comprises a maximum tree depth, and a first maximum tree depth for the initial decision trees in the initial trained model was 6, then processor 60 can specify that a second maximum tree depth for the further decision trees can be 10. In this example, processor 60 can generate the initial set of decision trees 78 with the first maximum tree depth, and generate the further set of decision trees 78 (i.e., for the augmented trained model) with the second maximum tree depth that is different than the first maximum tree depth. In this example, the second maximum tree depth is greater than the first maximum tree depth.

In a second example, a given parameter 112 comprises an incremental learning rate, and the incremental learning rate for the further decision trees will be different (typically less than) than the incremental learning rate for the initial decision trees. In this example, processor 60 can generate the initial set of decision trees 78 using a first incremental learning rate, and generate the further set of decision trees 78 (i.e., for the augmented trained model) with a second incremental learning rate.

When generating gradient boosted decision tree models, the learning rate is a hyperparameter that controls the contribution of each tree to the final prediction (i.e., model classification 58). The learning rate can be used to control the step size during the optimization process, and is crucial for balancing model performance, computational efficiency, and for avoiding overfitting.

In a third example, a given parameter 112 may comprise weight values for files 30B. In some embodiments, the weight values for files 30B can be less than the weight values for files 30A. For example, when training augmented trained model 32 by generating further decision trees 78, processor 60 can apply a weight value of 1.0 to files 30A whose respective labels 92 are benign, a weight value of 1.2 to files 30A whose respective labels 92 are malicious, a weight value of 0.1 to files 30B whose respective labels 92 are benign, and a weight value of 0.18 to files 30B whose respective labels 92 are malicious. The rationale for using different weight values is described hereinbelow.

Benign and malicious labels 92 are described hereinabove.

As described supra, each trained model 32 comprises an ordered sequence of decision trees 78. These decision trees are applied to a given training dataset 66 in a specific sequence indicated by their respective tree sequence number 120. As a sequence example, if there are five decision trees 78 in a given trained model 32, then the decision trees are applied to a given training dataset 66 in the following order:
1. A first given decision tree 78 in the given trained model whose respective sequence number 120 is 1.
2. A second given decision tree 78 in the given trained model whose respective sequence number 120 is 2.
3. A third given decision tree 78 in the given trained model whose respective sequence number 120 is 3.
4. A fourth given decision tree 78 in the given trained model whose respective sequence number 120 is 4.
5. A fifth given decision tree 78 in the given trained model whose respective sequence number 120 is 5.

In these embodiments the front end of the model is the first given decision tree (i.e., the first decision tree 78 in the given trained model) and the back end of the model is the fifth given decision tree (i.e., the last decision tree 78 in the given trained model.

Returning to the flow diagram, in step 150, processor 60 defines removal criteria that the server processor can use to identify which decision trees to remove from initial trained model 32. In embodiments herein, the removal criteria can be based on sequence number 120 or tree significance measure 122. In some embodiments, the removal criteria can be based on sequence number 120 if augmented trained model 32 is a first retraining of a given trained model 32 (i.e., initial trained model 32), and the removal criteria can be based on tree significance measure 122 if the augmented trained model 32 is a not the first (i.e., the second, third . . . ) retraining of the initial trained model 32.

If the removal criteria is based on sequence number 120 o, then in step 152, processor 60 identifies the specified first number of decision trees 78 for removal from the back end of initial trained model 32. Using the sequence example described supra, if the specified number is 2, then processor identifies the fourth given decision tree and the fifth given decision tree (i.e., at the back end of the given trained model.

In step 154, processor 60 removes the identified decision trees from the initial trained model, thereby defining an abridged trained model 32.

In step 156, processor 60 applies the abridged trained model to files 30C (i.e., files 30A and 30B) so as to generate respective training tree scores 137 from decision trees 118.

In step 158, processor 60 extracts respective second features 94 from training files 30B.

In step 160, processor 60 trains, using the respective first and second labels 92 and the extracted respective first and second file features 94 for files 30A and 30B, further decision trees 78 so as to generate augmented trained model 32. In some embodiments, processor 60 can use parameters 112 for generating further decision trees 78, as described supra.

Finally, in step 162, processor 60 deploys the augmented trained model to host computer 22, which stores the augmented trained model deployed model as deployed model 50. Processor 34 can then use deployed model 50 to classify further files such as production files 42, and the method ends. Upon deployed model 50 classifying a given production file 42 as being malicious, processor 34 can initiate a protective action such as quarantining (i.e., restricting access to) the given production file or generating an alert for the given production file.

Since deployed model 50 is a copy of given trained model 52, processor 34 can classify the further files using embodiments described hereinabove for classifying training files 30.

Returning to step 150, if the removal criteria is based on tree significance measure 122, then in step 166, processor 60 computes respective tree significance measures 122 for (corresponding) decision trees 78 in initial trained model 32. In embodiments of the present invention, each given tree significance measure 122 comprising a score (i.e., a value) that indicates a respective significance (i.e., impact) of the corresponding decision tree on the initial trained model.

When processor 60 trains a first iteration of a given trained model 32 (i.e., generates from scratch, and therefore not based on any retraining of any given previously trained model 32) based on a first given dataset 66, the first decision trees at the front end of the model have higher significance (i.e., generate stronger classifications) than the last decision trees at the back end of the model. In other words, the sequence of decision trees in the first iteration of the given decision model may be (somewhat) ordered based on their respective significance. However, once the first iteration of the given trained model has been retrained on a second given dataset (different from the first given dataset) so as to define a second iteration of the given trained model, the sequence of the decision trees in the second iteration of the given trained model is typically no longer in order of their respective significance.

In one embodiment, a lower tree significance measure 122 indicates a lower significance of the corresponding decision tree, and a higher tree significance measure 122 indicates a higher significance of the corresponding decision tree. In another embodiment, a lower tree significance measure 122 indicates a higher significance of the corresponding decision tree, and a higher tree significance measure 122 indicates a lower significance of the corresponding decision tree.

In a first score embodiment, processor 60 can compute tree significance measure 122 by applying each given initial decision tree 78 to training files 66C (i.e., their respective labels 92), and comparing the training classifications (i.e., training tree scores 137 indicating a verdict, e.g., by comparing the training tree scores to specified thresholds) generated by each given initial decision tree to its respective training file label 92. In this embodiment, a given tree significance measure 122 can indicate an accuracy (i.e., compared to training file labels 92) of the training classifications generated by its respective initial decision tree.

In a second score embodiment, tree significance measures 122 can be based on respective leaf values of leaf node 79. In this embodiment, processor 60 can compute the tree significance measure for each given decision tree 78 by first computing respective leaf values for all the leaf nodes in the given decision tree 78, and then computing a sum of all of the computed leaf values (i.e., for the given decision tree).

In gradient boosting decision trees such as decision trees 78, the leaf value for a given leaf node 79 represents the value of the target (i.e., a given file that processor 60 is classifying) that will be predicted for instances in the given leaf node, multiplied by the learning rate. In some embodiments, processor 60 can compute the leaf value for a given leaf node 70 by identifying training files 30 that fall into the given leaf node (i.e., when the decision trees 78 are applied to the training files), and performing a computation (e.g., sum, maximum, average or value) of the identified training files.

Returning to the flow diagram, in step 168, processor 60 identifies the specified first number (per step 148) of decision trees 78 whose respective tree significance measures 122 indicate a lowest significance on initial trained model 32, and the method continues with step 154.

As described supra, processor 60 can use different weight values for files 30A and 30B when retraining a first given model 32 so as to generate a second trained model 32. In some embodiments, processor 60 may assign higher weights to files 30A and lower weights to files 30B. As described hereinabove, files 30B may comprise similar files 30B that have different labels 92. Due to the similarity and the labels, a high percentage of files 30B may generate initial classification scores 137 having errors that the further decision trees 78 focus on for correction. Therefore, assigning lower weight values to files 30B can help reduce the impact of files 30B when processor 60 generates the further decision trees.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for protecting a computer system, comprising:
receiving first files, having respective first labels indicating whether the first files are harmful to operation of the computer system;
extracting respective first features from the first files;
training, by a processor, an initial gradient-boosted decision model comprising an initial set of decision trees based on the respective features and labels of the first files;
after training the initial gradient-boosted decision model, removing from the trained model some but not all of the decision trees in the initial set so as to define an abridged gradient-boosted decision model comprising an abridged set of the decision trees;
receiving second files, which are different from the first files and have respective second labels indicating whether the second files are harmful to operation of the computer system;
extracting respective second features from the second files;
computing respective initial classification scores for the first and the second files by applying the abridged gradient-boosted decision model to their respective features;
training, by the processor, an augmented gradient-boosted decision model by adding further decision trees to the abridged set based on the respective initial classification scores and respective labels and features of the first and the second files; and
applying the augmented gradient-boosted decision model to classify further files as either harmful or unharmful to the operation of the computer system.

2. The method according to claim 1, wherein the labels and the classification scores comprise verdicts indicating whether their respective files are harmful to operation of the computer system.

3. The method according to claim 2, wherein the second label for a given second file indicates a first verdict, and wherein the initial classification score for the given second file indicates a second verdict different from the first verdict.

4. The method according to claim 3, wherein a subset of the second files have specified respective similarities to the given second file, and wherein one or more of the second files in the subset have respective second labels different from the first verdict.

5. The method according to claim 4, wherein one or more of the second files in the in the subset have respective second labels matching the first verdict.

6. The method according to claim 4, wherein the specified similarity comprises a distance score between the one or more additional second files and the given second file.

7. The method according to claim 6, wherein the distance score comprises trend locality sensitive hash (TLSH) distance scores, and wherein the specified similarity comprises detecting that the TLSH distance scores are within a specified threshold of each other.

8. The method according to claim 1, wherein removing some but not all of the decision trees in the initial set comprises removing a specified number of the decision trees from the initial set.

9. The method according to claim 1, wherein the initial gradient-boosted decision model comprises a ordered sequence of the decision trees in the initial set from a front end of the initial gradient-boosted decision model to a back end of the initial gradient-boosted decision model, wherein removing the specified number of the decision trees from the initial set comprises removing the specified number of the decision trees from the back end of the initial gradient-boosted decision model.

10. The method according to claim 1, and further comprising computing, for each given decision tree in the initial set, a tree significance measure indicating its respective impact on the initial gradient-boosted decision model, wherein removing the specified number of the decision trees from the initial set comprises removing the specified number of the decision trees whose respective tree significance measure least impacts the initial gradient-boosted decision model.

11. The method according to claim 10, wherein computing the tree significance measure for a given decision tree in the initial set comprises computing respective test classifications for the first and the second files by applying the given decision tree to their respective features, and comparing the test classifications to the respective labels of the first and the second files, and wherein the tree significance measure for the given decision tree indicates an accuracy of the given decision tree.

12. The method according to claim 10, wherein the decision trees in the initial set comprise respective sets of leaf nodes, and further comprising computing respective leaf values for the leaf nodes, and computing the tree significance measure for a given leaf node by identifying one or more of the first files that fall into the given leaf node, and performing a computation on the identified one or more files.

13. The method according to claim 12, wherein the computation is selected from a list consisting of a sum, a maximum, an average and a value.

14. The method according to claim 1, wherein the further set of the decision trees comprises a specified number of further decision trees.

15. The method according to claim 1, wherein training the initial gradient-boosted decision model comprises generating the initial set of decision trees with a first value for a parameter, and wherein adding a further set of the decision trees comprises generating a further set of the decision trees with a second value for the parameter that is different than the first value for the parameter.

16. The method according to claim 15, wherein the parameter comprises a maximum tree depth.

17. The method according to claim 15, wherein the parameter comprises a learning rate.

18. The method according to claim 15, wherein the second incremental learning rate parameter is less than the first incremental learning rate parameter.

19. The method according to claim 1, wherein training the augmented gradient-boosted decision model comprises applying different respective weights to the first and the second files.

20. The method according to claim 19, wherein the weight for the first files is greater than the weight for the second files.

21. The method according to claim 19, wherein the weight for the first files comprises a first weight for the first files labeled as harmful to operation of the computer system, and a second weight for the first files labeled as not harmful to operation of the computer system, wherein the first weight is different than the second weight.

22. The method according to claim 19, wherein the weight for the second files comprises a first weight for the second files labeled as harmful to operation of the computer system, and a second weight for the second files labeled as not harmful to operation of the computer system, wherein the first weight is different than the second weight.

23. An apparatus for protecting a computer system, comprising:
a memory; and
a processor configured:
to receive first files, having respective first labels indicating whether the first files are harmful to operation of the computer system,
to extract and store to the memory respective first features from the first files,
to train an initial gradient-boosted decision model comprising an initial set of decision trees based on the respective features and labels of the first files,
after training the initial gradient-boosted decision model, to remove from the trained model some by not all of the decision trees in the initial set so as to define an abridged gradient-boosted decision model comprising an abridged set of the decision trees,
to receive second files, which are different from the first files and have respective second labels indicating whether the second files are harmful to operation of the computer system,
to extract and store to the memory respective second features from the second files,
to compute respective initial classification scores for the first and the second files by applying the abridged gradient-boosted decision model to their respective features,
to train an augmented gradient-boosted decision model by adding further decision trees to the abridged set based on the respective initial classification scores and respective labels and features of the first and the second files, and
to deploy the augmented gradient-boosted decision model so as to apply the augmented gradient-boosted decision model to classify further files as either harmful or unharmful to the operation of the computer system.

24. A computer software product for protecting a cloud computing system, the computer software product comprising a non-transitory computer-readable medium, in which program instructions are stored, which instructions, when read by a computer, cause the computer:
to receive first files, having respective first labels indicating whether the first files are harmful to operation of the computer system;
to extract respective first features from the first files;
to train an initial gradient-boosted decision model comprising an initial set of decision trees based on the respective features and labels of the first files;
after training the initial gradient-boosted decision model, to remove from the trained model some by not all of the decision trees in the initial set so as to define an abridged gradient-boosted decision model comprising an abridged set of the decision trees;
to receive second files, which are different from the first files and have respective second labels indicating whether the second files are harmful to operation of the computer system;
to extract respective second features from the second files;
to compute respective initial classification scores for the first and the second files by applying the abridged gradient-boosted decision model to their respective features;
to train an augmented gradient-boosted decision model by adding further decision trees to the abridged set based on the respective initial classification scores and respective labels and features of the first and the second files; and
to apply the augmented gradient-boosted decision model to classify further files as either harmful or unharmful to the operation of the computer system.
